(19) United States
(12) Patent Application Publication
(10) Pub. No.: US 2015/0053118 A1
(43) Pub. Date: Feb. 26, 2015

(54) METHOD FOR USING WASTE CONCRETE AS BLENDING MATERIAL IN CEMENT PRODUCTION AND CEMENT THUS OBTAINED

(71) Applicant: Wuji Yin, Changsha (CN)

(72) Inventor: Wuji Yin, Changsha (CN)

(21) Appl. No.: 14/377,647

(22) PCT Filed: Nov. 14, 2013
(86) PCT No.: PCT/CN2013/087173

§ 371 Date: Aug. 8, 2014

(30) Foreign Application Priority Data
Aug. 13, 2013 (CN) 201310349041.7

(51) Int. Cl. C04B 7/00

(52) U.S. Cl. CPC C04B 7/006
USPC 106/693

(57) ABSTRACT

The present disclosure relates to a method for manufacturing cement clinker with waste concrete as a blending material, comprising the steps of: i) crushing waste concrete into granules with particle size less than or equal to 40 mm; ii) adding the granules obtained in step i) to a cement production plant and mixing the granules with clinker in said production plant, wherein said granules are activated by the residual heat of said clinker, and then mixed with said clinker to directly serve as a blending material, and thus said cement clinker is manufactured. The present disclosure further relates to a cement comprising the cement clinker manufactured by said method.

### FIELD OF THE INVENTION

The present disclosure relates to the field of cement production, particularly to a method for using waste concrete as an activated blending material in cement production and cement thus obtained.

### BACKGROUND OF THE INVENTION

As one of the bulk building materials, cement is usually mixed with a certain amount of blending materials to reduce its production cost or improve its performance, i.e., cement is usually a mixture of clinker, blending materials, and gypsum, after being batched in a clinker batching system and then ground. Water quenched slag is most commonly used as an activated blending material, followed by phosphorus slag, steel slag, coal cinder, pulverized fuel ash, and other metallurgical slag. The adding amount of blending materials ranges from 5% to 50% by weight of the cement, depending on the types and strength grades of the cement. To reduce the production cost, the proportion of blending materials is as high as 60% to 80% in some cement manufacturing enterprises. The demands for blending materials are huge, while the resources of available activated blending materials are limited. Therefore, some enterprises have to use special burnt gangue, burnt shale, burnt clay, sandstone, and limestone as blending materials, and even some enterprises directly use a large quantity of raw gangue, carbonaceous shale, and clay minerals as blending materials to reduce the production cost. Except for normal strength and setting time, part of cement produced in this way is inferior cement which actually cannot be used in engineering projects and leads to more and more jerry-built projects.

On the other hand, more than one million tons of waste concrete becomes constriction waste every day in China due to large scale economic construction, and most of the waste concrete is discarded to low-lying lands or covered with soil while only a small part is used as aggregate and roadbed stuffing after being crushed.

It is well known that the basic components of concrete materials are hydrated cement stone (i.e., the product of cement after hydration) and aggregate (including fine aggregate and coarse aggregate). Aggregates usually are silica sand or breakstone, and a few are expanded perlite ceramsite, while most of breakstone is crushed carbonatite, i.e. limestone.

Currently, at home and abroad waste concrete is mainly used as filler, recycled cement, and recycled aggregate after crushing. For example, a company in Republic of Korea has reported that cement stone was separated from, waste concrete to produce renewable cement by high temperature treatment in a special baking furnace. China patent CN 200510136624.7 discloses a technology of reproducing cement by activating waste concrete, which separates out recycled cement and aggregate by heat treatment in a special baking furnace. However, the prior art is not desirable in the aspects of economical performance of practical application and users' psychological acceptability. Therefore, a new economically feasible method to solve the problem of the utilization of waste concrete is urgently needed, and an economical way of developing the supply channels of blending materials of cement is also needed.

### SUMMARY OF THE INVENTION

The technical problem to be solved by the present disclosure is to provide a method for using waste concrete as an activated blending material in cement production with features of simplicity and practicability, free of investment pressure, cost-efficiency, high acceptance, and suitability for mass production.

The present disclosure provides a method for manufacturing cement clinker with waste concrete as a blending material, comprising the steps of:
i) crushing waste concrete into granules with particle size less than or equal to 40 mm; and
ii) adding the granules obtained in step i) to a cement production plant and mixing the granules with clinker in said production plant, wherein said granules are activated by the residual heat of said clinker, and then mixed with said clinker to directly serve as a blending material, and thus the cement clinker is manufactured.

In one preferred embodiment of the present disclosure, said cement production plant includes a rotary kiln and a grate cooler connected to said rotary kiln. Said rotary kiln has a cooling zone therein and includes a kiln head and a clinker blanking mouth. The granules obtained in step i) are added to at least one region of the cooling zone in said rotary kiln, the clinker blanking mouth, and the grate cooler, and thermally activated by the residual heat of the clinker produced in the rotary kiln. Then the activated waste concrete is mixed with said clinker to directly serve as a blending material, and thus said cement clinker is manufactured.

In one preferred embodiment of the present disclosure, the adding amount of said granules ranges from 1-30% by weight of the clinker sintered in the rotary kiln.

In one further preferred embodiment of the present disclosure, the adding amount of said granules ranges from 5-20% by weight of the raw clinker sintered in the rotary kiln.

In one preferred embodiment of the present disclosure, the waste concrete is crushed into granules with particle size less than or equal to 20 mm, preferably less than or equal to 15 mm, and more preferably less than or equal to 12 mm.

In one preferred embodiment of the present disclosure, said waste concrete is selected from at least one of the group consisting of road and bridge waste concrete, industrial and civil construction waste concrete, waste bricks, waste mortar, and waste air entraining concrete.

In the present disclosure, said waste concrete is crushed by using conventional crushing equipments or crushing and screening equipments. Said waste concrete is added by a conventional equipment in a normal way.

The present disclosure further provides a cement comprising the cement clinker manufactured by the above method.

In one preferred embodiment of the present disclosure, 32.5 grade of said cement has a standard consistency of 22.5-25.5%, an average initial setting time of 109-154 min, and an average final setting time of 151-203 min.

In one preferred embodiment of the present disclosure, said cement has an average three-day compressive strength of 15.6-29.8 MPa, an average three-day rupture strength of 1.7-3.2 MPa, an average 28-day compressive strength of 35.3-58.1 MPa, and an average 28-day rupture strength of 3.9-6.1 MPa.

The technical principles of the present disclosure can be explained as follows, which are not to limit the scope of the present disclosure.

1. Concrete is made from cement and sandstone (aggregate) through hydration and curing. The basic components of waste concrete are cement stone and aggregate. The cement stone is formed by hydrated cementitious minerals generated from hydration of cement minerals such as calcium silicate, calcium aluminate, calcium ferroalumnates, calcium sulphoaluminate, and calcium oxide. Cementititous minerals constituting cement stone, including hydrated calcium silicate, hydrated calcium aluminate, hydrated calcium ferrite, hydrated calcium sulphoaluminate, calcium hydroxide, and other hydrous minerals, can be dehydrated into unsteady state (amorphous state and metastable subcrystalline state) products through heat treatment, which have the feature of hydration activity. In view of the above characteristics, cement stone can be directly treated and activated by the residual heat in the cooling process of high temperature clinker.

2. The activity of aggregate in waste concrete can be increased by heat treatment. For example, the commonly used silica sand, silica, granite, and other unreactive aggregate in aggregate can show certain activity upon generation of cracks through heat treatment; the commonly used limestone or dolomite in aggregate can partly or completely decompose to produce calcium oxide with high activity; and clay entrained in the granules of waste concrete can decompose to produce active silicon dioxide, aluminium oxide, and so on through heat treatment. Taking advantage of this characteristic, waste concrete is directly heat treated by the residual heat of high temperature clinker, to achieve the recycling of dehydrated and activated silicate cementitious minerals and enable the aggregate with certain activity.

3. A certain amount of light burned, high active, and non-compact free calcium in cement will not affect stability of the cement, but instead increase the initial alkali concentration and promote hydration of the cement, as well as improve workability of the cement. Thus the commonly used carbonate aggregate in waste concrete can be partly or totally transformed to active blending materials.

4. The blending materials can be mixed with clinker in a certain proportion for further batching, which will not affect the quality or stability of cement. Therefore, waste concrete is added to the high-temperature clinker in a high-temperature zone between the high-temperature clinker cooling zone at the kiln head and the grate cooler.

The beneficial effects of the present disclosure:

1) On the basis of analyzing and evaluating the characteristics of the constituent materials of waste concrete and the features of the technology and equipment of the dry process cement production line, the method of the present disclosure takes full advantage of the existing dry process cement production line without adding special heat treatment equipments for waste concrete, and does not affect normal production or increase heat consumption. In the process, waste concrete is activated through heat treatment only by the residual heat in the cooling process of high temperature clinker of 1450° C. Thus the method of the present disclosure adds no investment or cost pressure on cement production enterprises.

2) The waste concrete is directly heat treated by the residual heat in the cooling process of high temperature clinker, and the technology is simple and practical, with the advantages of adequate utilization of resources and large handling capacity.

3) The waste concrete is added to the high-temperature clinker in the high-temperature clinker zone between the cooling zone in the rotary kiln at 1350° C. and the grate cooler zone at 550° C. The aggregate, one constituent of waste concrete, such as calcium carbonate, can decompose to produce calcium oxide, which has high activity and can effectively increase the initial alkali concentration and the workability of the cement. While undecomposed calcium carbonate granules and crystalline silicon particles will not affect the strength of clinker within an appropriate amount. The hydrated minerals in the cement stone, one of the constituent materials of waste concrete, can be transformed to regenerated cement minerals with hydraulic activity after dehydration, which equals increasing the total output of the clinker minerals and meanwhile reducing the total energy consumption of the clinker.

4) The present disclosure develops a method of using waste concrete as a high quality blending material in an extremely economical way, which can solve the shortage and cost problems of blending materials to a certain extent. The method of the present disclosure helps to prevent the extensive use of poor quality blending materials in cement grinding, especially raw shale, raw gangue, and clay minerals, thus reducing the production of poor quality cement and the probability of jerry-built projects.

5) The method of the present disclosure involves neither secondary pollution, nor additional waste utilization and environmental protection costs.

### DETAILED DESCRIPTION OF THE EMBODIMENTS

The embodiments of the present disclosure will be further explained in connection with specific examples, whereby the procedures can be fully understood and therefore implemented as to how the present disclosure solves the technical problems by using the technical means and achieves the technical effects. It should be noted that, as long as there are no conflicts, the technical features disclosed in each and every example of the present disclosure can be combined with one another in any way, and all technical solutions formed are within the scope of the present disclosure.

### EXAMPLE 1

In the Φ3×47 m dry process rotary kiln production line of a plant, during regular production, the clinker had a standard consistency of 22.4-25.1%, an initial setting time of 85-138 min, an average initial setting time of 117 min, a final setting time of 126-183 min, an average final setting time of 158 min, an average three-day compressive strength of 28.1 MPa, an average three-day rupture strength of 3.1 MPa, an average 28-day compressive strength of 54.6 MPa, and an average 28-day rupture strength of 5.7 MPa. Coal cinder, black shale, and blast, furnace slag in a ratio of 1:1:1 were previously used as a blending material in the plant. Natural dihydrate gypsum was used. The total amount of the blending material used in cement of 32.5 grade was 48 wt %. The produced cement had a standard consistency of 24.1-25.5%, an average initial setting time of 147 min, an average final setting time of 215 min, an average three-day compressive strength of 16.3 MPa, an average three-day rupture strength of 1.9 MPa, an average 28-day compressive strength of 35.3 MPa, and an average 28-day rupture strength of 3.7 MPa. The workability of the cement was poor (non-slurrying, segregating, and bleeding). Especially when used in laying floors and the exterior of buildings, there is lot of sugaring appearing and even no strength on its surface.

In the method of the present disclosure, aluminium oxide ceramics gathering sill was lined with phosphate aluminium used in nickel-chromium steel, and waste concrete discarded in the valleys was crushed into granules with particle size less than or equal to 10 mm. The granules thus obtained were added to the kiln cooling zone through the kiln head. The feeding amount of waste concrete was 18 wt % of the raw clinker. The mixed cement clinker containing the waste concrete blending material thus manufactured had a standard consistency of 22.5-23.8%, an initial setting time of 89-121 min, an average initial setting time of 109 min, a final setting time of 130-171 min, an average final setting time of 151 min, an average three-day compressive strength of 29.3 MPa, an average three-day rupture strength of 3.4 MPa, an average 28-day compressive strength of 54.7 MPa, and an average 28-day rupture strength of 5.7 MPa. That is to say, the strength of the cement clinker obtained had no change basically compared with the strength of the original clinker. In the case of removing black shale from the blending material and retaining coal cinder and blast furnace slag, and 48 wt % of the blending material in the cement and same amount of gypsum, the cement of 32.5 grade had a standard consistency of 22.6-23.7%, an average initial setting time of 133 min, an average final setting time of 191 min, an average three-day compressive strength of 20.7 MPa, an average three-day rupture strength of 2.3 MPa, an average 28-day compressive strength of 39.1 MPa, and an average 28-day rupture strength of 4.1 MPa. The workability of the cement has been obviously improved, slurrying easily upon stir or use, no segregating, and the bleeding rate reduced by 80%. The strength of the cement has been improved obviously, and the previous phenomena of serious sugaring and even having no strength on its surface have been eliminated.

### EXAMPLE 2

In the Φ4.3×64 m dry process rotary kiln production line of a plant, during regular production, the clinker had a standard consistency of 22.8-24.9%, an initial setting time of 121-173 min, an average initial setting time of 154 min, a final setting time of 191-233 min, an average final setting time of 216 min, an average three-day compressive strength of 29.1 MPa, an average three-day rupture strength of 3.2 MPa, an average 28-day compressive strength of 56.5 MPa, and an average 28-day rupture strength of 5.5 MPa. Limestone, black shale, and manganese slag in a ratio of 1:2:2 were previously used as a blending material in the plant. Desulfurized dihydrate gypsum was used. The amount of the blending material used in cement of 32.5 grade was 45 wt %. The produced cement had a standard consistency of 24.3-25.5%, an average initial setting time of 185 min, an average final setting time of 243 min, an average three-day compressive strength of 15.6 MPa, an average three-day rupture strength of 1.7 MPa, an average 28-day compressive strength of 35.3 MPa, and an average 28-day rupture strength of 3.6 MPa. The workability of the cement was poor (non-slurrying, segregating, and bleeding). Lots of sugaring occurred on the surface of cement especially when used on grounds.

In the method of the present disclosure, the road building waste concrete near the plant was crushed into granules with particle size less than or equal to 10 mm, and the granules thus obtained were added to the grate cooler through the clinker blanking mouth at the kiln head. The feeding amount of the waste concrete was 15 wt % of the raw clinker. The mixed cement clinker containing the waste concrete blending material thus manufactured had a standard consistency of 23.5-24.8%, an initial setting time of 111-134 min, an average initial setting time of 123 min, a final setting time of 162-197 min, an average final setting time of 173 min, an average three-day compressive strength of 29.3 MPa, an average three-day rupture strength of 3.2 MPa, an average 28-day compressive strength of 56.7 MPa, and an average 28-day rupture strength of 5.7 MPa. That is to say, the strength of the cement clinker obtained had no change basically compared with the strength of the original clinker. In the case of removing black shale from the blending material, retaining 45 wt % of the blending material in the cement and same amount of gypsum, the cement of 32.5 grade had a standard consistency of 23.8-24.7%, an average initial setting time of 173 min, an average final setting time of 223 min, an average three-day compressive strength of 19.3 MPa, an average three-day rupture strength of 2.1 MPa, an average 28-day compressive strength of 39.1 MPa, and an average 28-day rupture strength of 4.1 MPa. The workability of the cement has been improved obviously, slurrying easily upon stir or use, no segregating, and the bleeding rate reduced by 85%. The previous phenomenon of serious sugaring has been substantially eliminated.

### EXAMPLE 3

In the Φ3.5×50 m dry process rotary kiln production line of a plant, during regular production, the clinker had a standard consistency of 22.4-24.3%, an initial setting time of 95-139 min, an average initial setting time of 117 min, a final setting time of 151-183 min, an average final setting time of 168 min, an average three-day compressive strength of 28.7 MPa, an average three-day rupture strength of 2.9 MPa, an average 28-day compressive strength of 58.5 MPa, and an average 28-day rupture strength of 5.7 MPa. Pulverized fuel ash, raw gangue, and blast furnace slag in a ratio of 1:1:1 were previously used as a blending material in the plant. Natural dihydrate gypsum was used. The amount of the blending material used in cement of 32.5 grade was 45 wt %. The produced cement had a standard consistency of 24.2-25.3%, an average initial setting time of 157 min, an average final setting time of 216 min, an average three-day compressive strength of 17.5 MPa, an average three-day rupture strength of 1.9 MPa, an average 28-day compressive strength of 35.6 MPa, and an average 28-day rupture strength of 3.5 MPa. The workability of the cement was poor (segregating and bleeding seriously). Severe sugaring occurred on the surface of cement especially when used on roads and serious cracking appeared during plastering.

In the method of the present disclosure, the construction waste from house demolition discarded on mountains containing waste concrete, waste bricks, and air entraining concrete was crushed into granules with particle size less than or equal to 10 mm, and the granules thus obtained were added to the clinker blanking mouth at the kiln head. The feeding amount of construction waste containing the waste concrete was 17 wt % of the raw clinker. The mixed cement clinker containing the waste concrete blending material thus manufactured had a standard consistency of 22.5-24.3%, an initial setting time of 91-129 min, an average initial setting time of 110 min, a final setting time of 145-173. min, an average final setting time of 157 min, an average three-day compressive strength of 28.6 MPa, an average three-day rupture strength of 3.0 MPa, an average 28-day compressive strength of 58.7 MPa, and an average 28-day rupture strength of 5.7 MPa. That is to say, the strength of the cement clinker obtained had no change basically compared with that of the original clinker. In the case of removing raw gangue from the blending material, retaining 45 wt % of the blending material in the cement and same amount of gypsum, the cement of 32.5 grade had a standard consistency of 23.8-24.3%, an average initial setting time of 143 min, an average final setting time of 203 min, an average three-day compressive strength of 19.1 MPa, an average three-day rupture strength of 2.3 MPa, an average 28-day compressive strength of 39.1 MPa, and an average 28-day rupture strength of 3.9 MPa. The workability of the cement has been improved obviously, slurrying easily upon stir or use, no segregating, and the bleeding rate reduced by 85%. The previous phenomena of serious sugaring and cracking have been substantially eliminated.

### EXAMPLE 4

In the Φ4.8×72 in dry process rotary kiln production line of a plant, during regular production, the clinker had a standard consistency of 22.4-24.5%, an initial setting time of 93-129 min, an average initial setting time of 116 min, a final setting time of 156-183 min, an average final setting time of 168 min, an average three-day compressive strength of 31.3 MPa, an average three-day rupture strength of 3.3 MPa, an average 28-day compressive strength of 57.5 MPa, and an average 28-day rupture strength of 5.5 MPa. Coal cinder, pebble, and blast furnace slag in a ratio of 2:1:2 were previously used as a blending material in the plant. Desulfurized gypsum was used. The amount of the blending material used in cement of 32.5 grade was 48 wt %. The produced cement had a standard consistency of 23.2-24.5%, an average initial setting time of 147 min, an average final setting time of 215 min, an average three-day compressive strength of 21.6 MPa, an average three-day rupture strength of 2.3 MPa, an average 28-day compressive strength of 40.3 MPa, and an average 28-day rupture strength of 3.9 MPa. The workability of the cement was poor (segregating and bleeding badly). Severe sugaring occurred on the surface of cement especially when used on roads.

In the method of the present disclosure, the highway waste concrete was crushed into granules with particle size less than or equal to 12 mm, and the granules thus obtained were added to the clinker blanking mouth at the kiln head. The feeding amount of the waste concrete was 12 wt % of the raw clinker. The mixed cement clinker containing the waste concrete blending material thus manufactured had a standard consistency of 22.6-24.5%, an initial setting time of 89-121 min, an average initial setting time of 109 min, a final setting time of 140-161 min, an average final setting time of 152 min, an average three-day compressive strength of 31.5 MPa, an average three-day rupture strength of 3.3 MPa, an average 28-day compressive strength of 57.4 MPa, and an average 28-day rupture strength of 5.7 MPa. That is to say, the strength of the cement clinker obtained had no change basically compared with the strength of the original clinker. In the case of removing pebble from the blending material, retaining 48 wt % of the blending material in the cement and same amount of gypsum, the cement of 32.5 grade had a standard consistency of 22.6-23.7%, an average initial setting time of 133 min, an average final setting time of 201 min, an average three-day compressive strength of 22.6 MPa, an average three-day rupture strength of 2.3 MPa, an average 28-day compressive strength of 43.6 MPa, and an average 28-day rupture strength of 4.5 MPa. The workability of the cement has been improved obviously, slurrying easily upon stir or use, no segregating, and the bleeding rate reduced by 90%. The previous phenomenon of serious sugaring has been substantially eliminated.

### EXAMPLE 5

In the Φ3.5×48 m dry process rotary kiln production line of a plant, during regular production, the clinker had a standard consistency of 23.1-24.3%, an initial setting time of 131-153 min, an average initial setting time of 143 min, a final setting time of 186-219 min, an average final setting time of 208 min, an average three-day compressive strength of 30.1 MPa, an average three-day rupture strength of 3.2 MPa, an average 28-day compressive strength of 58.5 MPa, and an average 28-day rupture strength of 6.1 MPa. Coal cinder, burned shale, and blast furnace slag in a ratio of 1:2:1 were previously used as a blending material in the plant. Natural dihydrate gypsum was used. The amount of the blending material used in cement of 32.5 grade was 50 wt %. The produced cement had a standard consistency of 24.3-25.5%, an average initial setting time of 187 min, an average final setting time of 243 min, an average three-day compressive strength of 17.1 MPa, an average three-day rupture strength of 1.9 MPa, an average 28-day compressive strength of 35.6 MPa, and an average 28-day rupture strength of 3.6 MPa. The workability of the cement was poor (segregating and bleeding seriously). Especially when used on grounds, there is lot of sand streak appearing on the surface of cement and even no strength on its surface.

In the method of the present disclosure, the waste concrete discarded near the plant was crushed into granules with particle size less than or equal to 10 mm, and the granules thus obtained were added to the blanking mouth at the kiln head. The feeding amount of the waste concrete was 20 wt % of the raw clinker. The mixed cement clinker containing the waste concrete blending material thus manufactured had a standard consistency of 23.5-24.5%, an initial setting time of 125-147 min, an average initial setting time of 131 min, a final setting time of 173-196 min, an average final setting time of 181 min, an average three-day compressive strength of 29.8 MPa, an average three-day rupture strength of 3.2 MPa, an average 28-day compressive strength of 58.1 MPa, and an average 28-day rupture strength of 6.1 MPa. That is to say, the strength of the cement clinker thus obtained had no change basically compared with the strength of the original clinker. In the case of removing burned shale from the blending material, retaining 50 wt % of the blending material in the cement and same amount of gypsum, the cement of 32.5 grade had a standard consistency of 23.6-24.7%, an average initial setting time of 159 min, an average final setting time of 218 min, an average three-day compressive strength of 21.7 MPa, an average three-day rupture strength of 2.3 MPa, an average 28-day compressive strength of 39.6 MPa, and an average 28-day rupture strength of 4.1 MPa. The workability of the cement has been improved obviously, slurrying easily upon stir or use, no segregating, and the bleeding rate reduced by 90%. The previous phenomena of serious sugaring and no strength on the surface have been substantially eliminated.

1. A method for manufacturing cement clinker with waste concrete as a blending material, comprising the steps of:
i) crushing waste concrete into granules with particle size less than or equal to 40 mm; and
ii) adding the granules obtained in step i) to a cement production plant and mixing the granules with clinker in said production plant, wherein said granules are activated by the residual heat of said clinker, and then mixed with said clinker to directly serve as a blending material, and, thus said cement clinker is manufactured.

2. The method of claim 1, wherein said cement production plant includes a rotary kiln and a grate cooler connected to the rotary kiln, the rotary kiln having a kiln cooling zone therein, a kiln head, and a clinker blanking mouth; and
wherein the method comprises adding the granules obtained in step i) to at least one region of the cooling zone in said rotary kiln, the clinker blanking mouth, and the grate cooler; thermally activating the granular waste concrete by the residual heat of the clinker produced in the rotary kiln; and mixing the activated waste concrete with said clinker to directly serve as a blending material, thus manufacturing the cement clinker is manufactured.

3. The method of claim 1, wherein the adding amount of said granules ranges from 1% to 30% by weight of the clinker sintered in the rotary kiln.

4. The method of claim 1, wherein the adding amount of said granules ranges from 5% to 20% by weight of the raw clinker sintered in the rotary kiln.

5. The method of claim 1, wherein the particle size of said granules is less than or equal to 20 mm.

6. The method of claim 5 wherein said waste concrete is crushed into granules with particle size less than or equal to 15 mm.

7. The method of claim 5, wherein said waste concrete is crushed into granules with particle size less than or equal to 12 mm.

8. A cement comprising the cement clinker manufactured by said method of claim 1.

9. The cement of claim 8, wherein 32.5 grade of said cement has a standard consistency of 22.5-25.5%, an average initial setting time of 109-154 min, and an average final setting time of 151-203 min.

10. The cement of claim 8, wherein said cement has an average three-day compressive strength of 15.6-29.8 MPa, an average three-day rupture strength of 1.7-3.2 MPa, an average 28-day compressive strength of 35.3-58.1 MPa, and an average 28-day rupture strength of 3.9-6.1 MPa.

11. The method of claim 2, wherein the adding amount of said granules ranges from 1% to 30% by weight of the clinker sintered in the rotary kiln.

12. The method of claim 2, wherein the adding amount of said granules ranges from 5% to 20% by weight of the raw clinker sintered in the rotary kiln.

13. The method of claim 2, wherein the particle size of said granules is less than or equal to 20 mm.

14. The cement of claim 9 wherein said cement has an average three-day compressive strength of 15.6-29.8 MPa, an average three-day rupture strength of 1.7-3.2 MPa, an average 28-day compressive strength of 35.3-58.1 MPa, and an average 28-day rupture strength of 3.9-6.1 MPa.
